(19) United States
(12) Patent Application Publication
(10) Pub. No.: US 2008/0215445 A1
(43) Pub. Date: Sep. 4, 2008

(54) CUSTOMER SERVICE MARKETING

(76) Inventors: Steve Horton, Westlake Village, CA (US); Steve Philips, West Hills, CA (US); Rob Lee, Jacksonville, FL (US)

Correspondence Address: SoCAL IP LAW GROUP LLP, 310 N. WESTLAKE BLVD. STE 120, WESTLAKE VILLAGE, CA, 91362, US

(21) Appl. No.: 12/122,620

(22) Filed: May 16, 2008

Related U.S. Application Data
(63) Continuation of application No. 11/165,789, filed on Jun. 23, 2005.
(60) Provisional application No. 60/583,017, filed on Jun. 28, 2004.

(51) Int. Cl. G06Q 30/00

(52) U.S. Cl. 705/14

(57) ABSTRACT

Customer service marketing is disclosed. After a customer communication is received and the customer is assigned to a service agent, service request information may be received from the service agent after the service request information is obtained by the service agent from the customer. A service response information may be provided to the service agent. A plurality of current offers may be obtained. A compendium score for each of the current offers may be prepared. At least one of the current offers may be selected to be provided to the customer based on the compendium scores. Cue information may be provided to a service agent based on the selected offer. The customer may be transferred to a specialist to facilitate the customer's purchase of a product or service described in the selected offer.

### RELATED APPLICATION INFORMATION

This patent application is a continuation of U.S. patent application Ser. No. 11/165,789 filed Jun. 23, 2005 which claims priority from Provisional Patent Application No. 60/583,017 filed Jun. 28, 2004, both of which are incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The invention relates to marketing additional products or services to customers contacting a company for customer service.

2. Description of the Related Art

Customers regularly contact customer service centers to obtain help with or additional information concerning a product or service. The service center may be maintained by a product or service provider or by another entity retained to provide customer service support.

Customers who contact customer service centers have traditionally contacted customer service centers by telephone. More recently, customers have been using email and on-line interactive text messaging to contact customer service.

The customer who contacts customer service voluntarily is an opportune target for the marketing of additional products and services.

### DESCRIPTION OF THE DRAWINGS

FIG. 1 is a block diagram of a system topology in which a customer service marketing method may be implemented.

FIG. 2 is a block diagram showing some of the software included in computers that may participate in a method of customer service marketing.

FIG. 3 is a first flow chart of a method of customer service marketing.

FIG. 4 is a second flow chart of a method of customer service marketing.

### DETAILED DESCRIPTION OF THE INVENTION

Throughout this description, the embodiments and examples shown should be considered as exemplars, rather than limitations on the systems and methods described herein.

A System

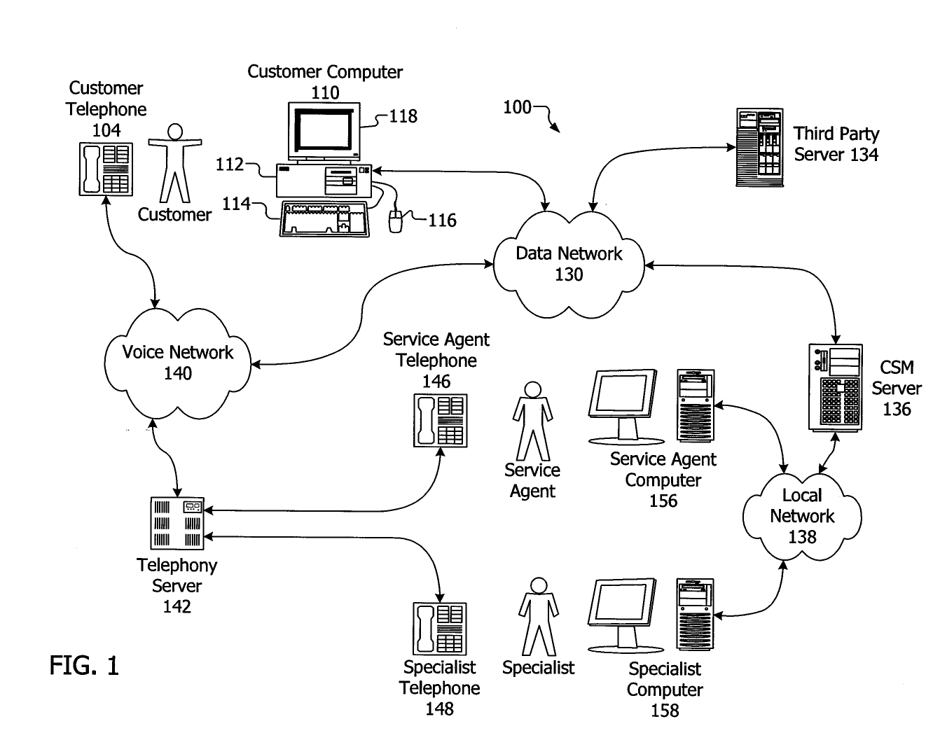

Referring now to FIG. 1 there is shown a block diagram of a system topology 100 in which a customer service marketing (CSM) method may be implemented. The system topology 100 may include a customer telephone 104, a customer computer 110, a data network 130, a CSM server 136, a voice network 140, a telephony server 142, a local network 138, a service agent telephone 146, a service agent computer, a specialist telephone 148, a specialist computer 158, and a third party server 134.

The customer may initiate a customer service interaction with a service or product provider by calling a service agent via customer telephone 104 over voice network 140 and/or communicating by interactive text message via customer computer 110 via data network 130. As used herein, “service agent” refers to an employee, contractor, or other person who provides customer support for services or products provided by a particular company. The service agent may work for the service or product providing company or may work for another company who provides customer support services to the service or product providing company. Service agent may be short for customer service agent. The service agent may participate in the customer service interaction using service agent telephone 146 and/or service agent computer 156.

The customer computer 110, as well as the service agent computer 156 and the specialist computer 158, may be a general purpose personal computer. The customer computer 110 may include a system unit 112, an output device, such as a display 118, and one or more input devices, such as, for example, a keyboard 114, a mouse 116, a track ball, a pen or stylus, a touch pad, a data glove, and others.

The customer computer 110 may have a hard disk drive and/or other storage devices included therein or otherwise coupled with or accessible to the system unit 112. As used herein a storage device is a device that includes and may be used to read from and write to a storage medium. Storage devices include, hard disk drives, digital versatile disk (DVD) drives, compact disk (CD) drives, microdrives, flash memory devices, and others. Storage media are machine readable and include, for example, magnetic media such as hard disks, floppy disks and tape; optical media such as CDs and DVDs; flash memory cards; and other storage media.

The system unit 112 may have included therein a motherboard having a processor and memory, such as, for example, random access memory (RAM), as well as controller devices, add-on boards, interface boards, and other devices, such as for example, a graphics adapter, a network interface card (NIC), a sound card, and others.

The customer computer 110 may be a computing device such as, for example, a personal computer, computer workstation, server, portable computer, notebook computer, personal digital assistant (PDA), computing tablet, two-way messaging device (e.g., Blackberry™), smart display terminal, personal video recorder (PVR), set-top box, cellular telephone, satellite telephone, digital camera, digital music device such as, for example, an MP3 player, and others. The customer computer 110 may also be a home appliance such as a television, a refrigerator, and others.

The customer computer 110 may run an operating system, such as, for example, a version of Microsoft Windows, Linux, Unix, Apple MAC OS, Palm OS, and others.

The customer computer 110 connects with and communicates on the data network 130 and may include an interface therefore. The customer computer 110 may include a NIC, a modem or other device that supports communications on data network 130. The communications supported by the customer computer 110 may adhere to one or more communications standards. The communications standards may include wired and wireless communications protocols, such as, for example, one or more versions of the User Datagram Protocol (UDP), the Transmission Control Protocol (TCP), and the Internet Protocol (IP), the and/or 40 Gigabit Ethernet standards, the Fibre Channel standards, one or more varieties of the IEEE 802 standards, including 802.3 Ethernet, 802.11 Wi-Fi and 802.16 WiMAX, Asynchronous Transfer Mode (ATM), X.25, Integrated Services Digital Network (ISDN), token ring, frame relay, Point to Point Protocol (PPP), Fiber Distributed Data Interface (FDDI); proprietary protocols; and other protocols. Other communications standards supported by customer computer 110 may include Universal Serial Bus (USB), IEEE 1394 commonly known as FireWire and i.link, BlueTooth, and ZigBee. The customer computer 110 may be coupled with a modem, gateway or router to connect with and communicate on the data network 130.

The data network 130 provides network communications support for the customer computer 110 to interact with other devices, including the CSM server 136. The data network 130 is packet-switched and may comprise one or more public and/or private data networks and may include one or more Local Area Networks (LANS), Wide Area Networks (WANs), Storage Area Networks (SANs), and other networks and sub-networks. The data network 130 may include or be the Internet and may utilize the Internet Protocol.

The CSM server 136 and the third party server 134 may be a typical computer server that includes a processor, memory and storage devices. The CSM server 136 and the third party server 134 include a communications interface that allows the CSM server 136 and the third party server 134 to communicate with the customer computer 110, the telephony server 142 and other computing devices over the data network 130 using one or more of the communications standards described above. The communications interface may be a NIC.

The CSM server 136 may serve data and/or Internet web pages to customer computer 110, service agent computer 156, specialist computer 158, and other computing devices. The third party server 134 may serve data and Internet web pages to customer computer 110, to CSM server 136, and other computing devices. The CSM server 136 and the third party server 134 are servers that may include software to be one or more of a database server, a transaction server, a web server, and others. The CSM server 136 and the third party server 134 may run an operating system, such as, for example, a version of Microsoft Windows, Linux, Unix, Solaris, Apple MAC OS, and others.

Although only one each of the CSM server 136 and the third party server 134 are shown, the CSM server 136 and the third party server 134 may each represent any number of servers. The CSM server 136 and the third party server 134 may each represent a group of servers, network capable storage devices, routers, gateways and other communications devices. In addition, CSM server 136 and the third party server 134 may each be coupled with or communicate over data network 130 with other servers that provide telephone and other services via voice network 140.

The telephony server 142 may be a specialized server that includes a processor, memory and storage devices. The telephony server 140 includes a telephony interface that allows telephony server 142 to provide telephonic communications with customer telephone 104, service agent telephone 146, and specialist telephone 148. The telephony server 142 may serve as a signaling gateway platform (SGP), which is an intelligent service exchange node that integrates services between circuit switched and packet switched networks such as, for example, voice network 140 and data network 130. The telephony server 142 includes a communications interface that allows telephony server 142 to communicate with third party server 134 and CSM server 136 over the data network 130 using one or more of the communications protocols described above. The communications interface may be a NIC.

The telephony server 142 may include an operating system, communications software, and telephony software. The telephony server 142 may receive incoming customer telephone calls, obtain basic customer information and other information, and transfer the customer call to a service agent telephone in conjunction with or independently of communications with CSM server 136. The telephony server 142 may communicate with CSM server 136 over voice network 140 and data network 130. In other embodiments, the telephony server 142 may be directly coupled with CSM server 136, or may communicate with CSM server 136 over local network 138. In addition, the telephony server 142 may be coupled with or communicate over data network 130 with other servers including CSM server 136.

Although only one telephony server 142 is shown, the telephony server 142 represents any number of servers. The telephony server 142 may represent a group of servers, network capable storage devices, routers, gateways, switches and other communications devices.

The voice network 140 is a common carrier network which provides telephone service between customers. The voice network 140 may be or include a circuit-switched network, a packet-switched network, a data network, an IP telephony network, or include or be a combination thereof. The voice network 140 may be the public switched telephone network (PSTN). The voice network 140 may operate according to one or more telephony standards such as, for example, Common Channel Interoffice Signaling (CCIS), Common Channel Signaling 7 (C7), Signaling System 6 (SS6), Voice Over Internet Protocol (VoIP), and Signaling System 7 (SS7) standards. The voice network 140 may also operate according to one or more of the communications standards, other data communications and/or other telecommunications standards. The voice network 140 may be a hybrid network that includes both circuit-switched and packet-switched communications.

The customer telephone 104, the service agent telephone 146 and the specialist telephone 148 may be analog telephones connected to the voice network 140, as shown. In other embodiments, the customer telephone 104, the service agent telephone 146 and the specialist telephone 148 may be digital devices for providing voice communications, such as, for example, session initiation protocol (SIP) or media gateway control protocol (MGCP) enabled telephone sets. The customer telephone 104, the service agent telephone 146 and the specialist telephone 148 may also be wireless voice communications devices such as cellular telephones or other mobile telephones. As used herein the terms “telephone” and “phone” refer to analog telephones, digital telephones, cellular telephones, satellite telephones, IP telephones, and telephones supporting VoIP, SIP, MGCP and other telephony protocols.

There may be one or more customers having one or more customer telephones 104 which may be located proximate to the customer computer 110 and/or in a location under common control of the customer of the customer computer 110. Or the customer and customer telephone 104 may be remote from customer computer 110. Although only one each of the service agent and the specialist are shown, an unlimited number of service agents and specialists may be included. Although only one each of the service agent telephone 146, service agent computer 156, specialist telephone 148 and specialist computer 158 are shown, an unlimited number of each of these may be included in the system topology 100.

In addition, multiple groups of service agents, service agent telephones 146 and service agent computers 156 may be located in multiple locations. Similarly, multiple groups of specialists, specialist telephones 148 and specialist computers 158 may be located in multiple locations.

The service agent computers 156 and specialist computers 158 may communicate over the local network 138 with CSM server 136. In another embodiment, the service agent computers 156 and specialist computers 158 may communicate directly with the CSM server 136. In yet another embodiment, the service agent computers 156 and specialist computers 158 may communicate over the local network 138 with one another or may communicate directly with one another.

Although the specialist, the specialist telephone 148 and the specialist computer 158 are depicted near the service agent, the service agent telephone 146 and the service agent computer 156, one or more specialists, specialist telephones 148 and specialist computers 158 may be located remote from the service agents, and no specialist may be located near the service agents. Specialists may be employed by, be a contractor of, or be otherwise affiliated with a third party product or service provider. The specialists, specialist telephones 148 and specialist computers 158 may access the data network 130 and voice network 140 directly, through a third party server 134, and/or through a third party telephony server, not shown.

The third party server 134 may communicate with the CSM server 136 over data network 130, via another network, or via a direct connection. The third party server 134 may communicate with the service agent computer 156 over a network such as data network 130 or via a direct connection.

All computer communications between, from and/or to the service agent computer 156, the CSM server 136, the specialist computer 158, third party server 134, and the customer computer 110 be they over data network 130, the local network 138 or over one or more other networks may be encrypted, secure or otherwise kept private. For example, communications between, from and/or to the service agent computer 156, the CSM server 136, the specialist computer 158, third party server 134 may be made using secure sockets layer (SSL) encryption.

The hardware and software of the invention and its functions may be distributed such that some components are performed by the CSM server 136, the telephony server 142, and/or others. The methods described herein may be embodied in whole or in part in software which operates on the CSM server 136 and the telephony server 142; and the methods described herein may operate in conjunction with the customer computer 110, the service agent computer 156, the service agent telephone 146, and the customer telephone 104. When implemented in software, the invention may be one or more of or a combination of application programs, applets (e.g., a Java applet), browser plug-ins, COM objects, dynamic linked libraries (DLLs), scripts, subroutines, operating system components or services, terminate and stay resident (TSR) programs, and/or other software entities. Some or all of the software may be stored on storage media included in or accessible to the devices shown in topology 100.

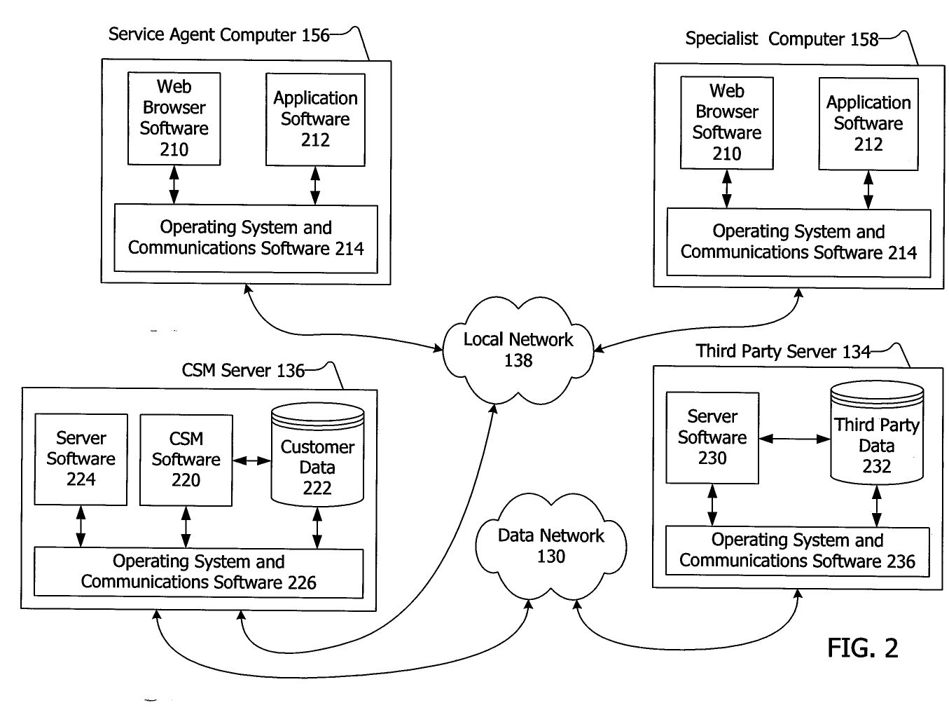

FIG. 2 is a block diagram showing some of the software included in computers that may participate in a method of customer service marketing. Customer computer 110, service agent computer 156 and specialist computer 158 may be similarly configured. The customer computer 110, service agent computer 156 and specialist computer 158 may include web browser software 210, application software 212, and operating system and communication software 214. The application software 212 may include, for example, without limitation, word processors (e.g., Microsoft Word), messaging software (e.g., Yahoo Messenger), electronic mail clients (e.g., Eudora by Qualcomm), and others. The web browser software 210 may be a dedicated Internet browser such as Microsoft Internet Explorer and Mozilla Firefox, may be part of an Internet software bundle such as Netscape Communicator, may be an online access program that provides support for Internet browsing such as America Online and NetZero, or may be another application program that allows for Internet browsing. The web browser software 210 may provide support for various communications over data network 130 such as, for example, the Hyper-Text Transfer Protocol (HTTP); may support multimedia display standards that may include mark-up languages such as the Hyper-Text Markup Language (HTML), active server pages (ASP), the Extensible Markup Language (XML) and others; and may support executable applets and other programming techniques such as the Microsoft .NET framework and Java.

The web browser software 210, application software 212, and operating system and communication software 214 may be stored on a storage device included in, coupled with or otherwise accessible to the customer computer 110, the service agent computer 156 and specialist computer 158.

The CSM server 136 may include and execute an operating system and communications software 226 which support communication over data network 130 by server software 224 and CSM software 220. The server software 224 and CSM software 220 may be combined as a single software component. The CSM software 220 may include and/or have access to one or more databases of information which may be available locally to or remotely from the CSM server 136. The database information may include information in the form of a customer data database 222, an offer data database (not shown), and/or another database.

The CSM software 220 may provide a graphical user interface to receive service request information from the service agent computer 156 and to provide service response information and customized targeted offer information to the service agent computer 156, all over local network 138 and/or directly. The graphical user interface of the CSM software 220 may provide text entry fields, pull-down menus, buttons, sliders, and other user interface items that allow and/or prompt a service agent to enter or provide basic information, additional information, and customer request information. The CSM software 220 may provide web pages using well known web page techniques and accessed by the service agent using a web browser. In another embodiment, the user interface may be provided, for example, by a CSM client application program (one of the application software 212) running on the service agent computer 156. In this embodiment, the CSM client application program may communicate with the CSM software 220 over local network 138 or directly.

The third party server 134 may include and execute an operating system and communications software 236 which support communication over data network 130 by server software 230. The server software 230 may provide additional customer information from one or more databases to the CSM software 220 on the CSM server 136. The server software 230 may include and/or have access to one or more databases of information which may be available locally to and/or remotely from the third party server 134. The database information may include additional customer information from third party data database 232, additional offer information from a third party offer database (not shown), or other information from another database.

The third party server 134 may provide historical information to the CSM server 136. The historical information may include offer acceptance rates and offer acceptance trends. The third party server 134 may provide offer acceptance information to the CSM server 136 in real time as offers are made and accepted or rejected. The CSM software 220 on CSM server 136 may compute historical response rates, response trends and other similar information based on the acceptance information received from the third party server 134.

Description of Methods

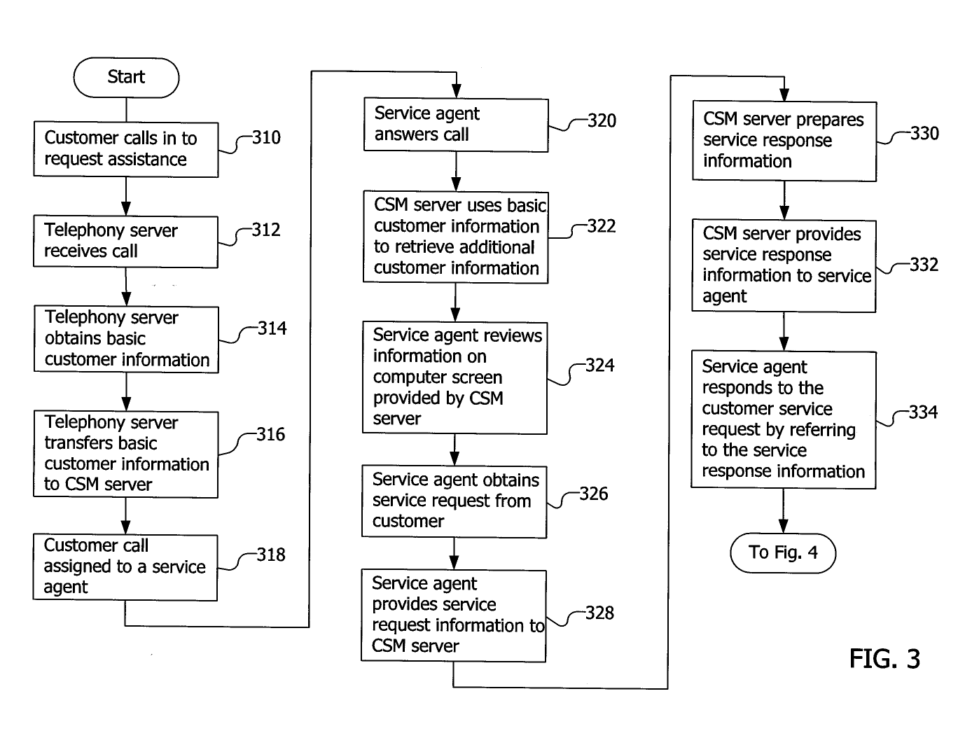

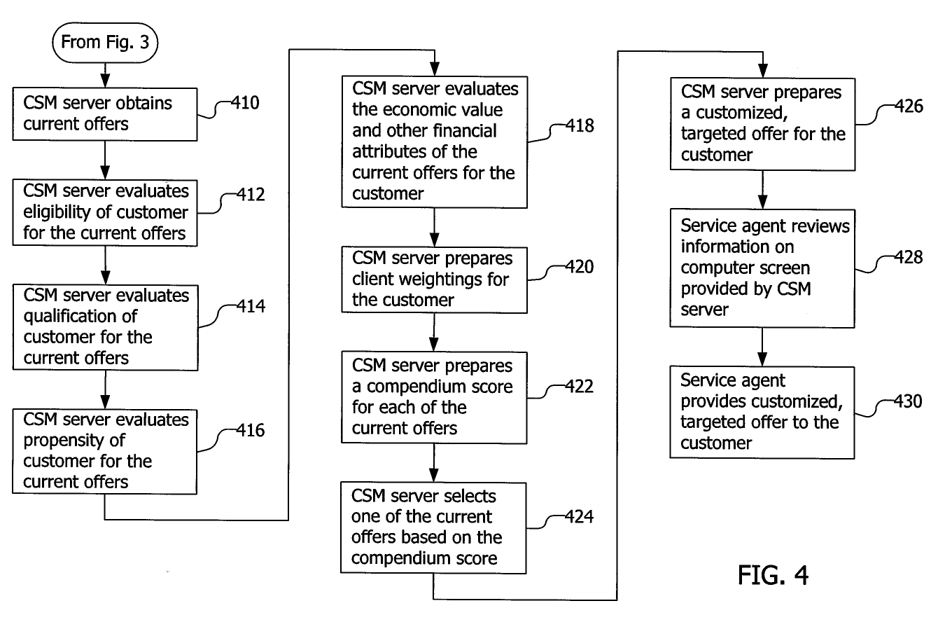

Referring now to FIG. 3, there is shown a first flow chart of a method of customer service marketing. FIG. 4 is a second flow chart of a method of customer service marketing. With regard to FIGS. 3 and 4, the actions taken in FIG. 4 may be performed concurrent with and/or interleaved with the actions taken in FIG. 3.

The method described herein in particularly useful in evaluating which of a plurality of current offers to market to a banking, mortgage, loan, credit card, credit line or other financial institution or financial product customer. The current offers may be provided by the originator of the product about which the customer has called or may be provided by another company referred to herein as a third party. The third party may have a strategic and/or corporate relationship with the originating company. The current offers may be related to the product or service about which the customer initiated the customer service interaction, or may be a product or service that, based on various factors, is determined to be a product or service the customer may be interested in. For example, the products or services may include financial products such as, for example, a home equity loan, a home equity line of credit, a second mortgage, a certificate of deposit (CD), a mutual fund, a retirement investment product (e.g., individual retirement account or IRA), and a school savings investment product (e.g., 529 plan); insurance products such as health insurance, auto insurance, life insurance and disability insurance; an extended warranty for a home or vehicle, an offer for a new vehicle or new appliances (e.g., clothes washer, clothes dryer, dishwasher); utility offers such as phone service, high speed Internet access (e.g., DSL, cable modem); dining clubs and shopping clubs; and others.

A current offer is selected and provided to a customer when a compendium score, described in more detail below, is met. That is, based on mathematical and other analysis of data concerning the customer and other factors and information including information about currently available product or service offers, an offer that the customer is likely qualified for and that has a chance of being accepted by the customer may be selected for and provided to the customer who initiated a customer service interaction. The selected current offer may be one of multiple offers for which the customer is likely qualified for and that has a chance of being accepted by the customer.

Beginning with FIG. 3, a customer may call in to request assistance, as shown in block 310. This is often achieved by the customer calling a publicized toll-free telephone number that connects a customer with a customer service assistance center. The telephony server of the customer service center receives the customer's call, as shown in block 312. The telephony server may obtain basic customer information from the customer, as shown in block 314. This may be achieved by an automated system, such as, for example, an interactive voice response (IVR) system. The customer may speak or use telephone touch tones (e.g., DTMF) to provide basic customer information to the telephony server. The basic customer information may include one or more of an account number, a transaction number, an address, an account name, a product name, a customer name, a birth date, a social security number, a product serial number, and/or other similar information. The basic information may also include a simple categorical description of the reason for the customer service call. For example, the categorical descriptions may include interest earned query, capital gains earned, address change, owner change, next payment due date, last payment made date, impound account information, tax information, pay off information request, and others. The categorical description may be selected by the customer by voice command, telephone touch tones, or other technique.

The telephony server transfers the basic customer information to the CSM server, as shown in block 316. The customer call is assigned to a service agent, as shown in block 318. This may be achieved, in various embodiments, by the telephony server, the CSM server, or another component of the CSM system. The service agent answers the customer call, as shown in block 320. The CSM server uses the basic customer information to retrieve additional customer information from, for example, the CSM database, as shown in block 322. The service agent reviews on a computer screen information provided by the CSM server, as shown in block 324. The service agent obtains service request information from the customer, as shown in block 326. The service agent provides service request information to the CSM server, as shown in block 328. This may be achieved by entering information into a graphical user interface provided by the CSM server software, such as for example, text entry fields, pull-down menus, buttons, sliders, and other user interface items. The user interface may be provided, for example, by a CSM client application program running on a service agent computer, or may be provided by web pages using well known web page techniques and accessed by the service agent using a web browser.

The CSM server prepares service response information, as shown in block 330. The CSM server provides service response information to the service agent, as shown in block 332. The service response information may be customized and contoured based on various information about the user. The service response information is used by the service agent to respond to the customer's service request. More specifically, the CSM server may provide the service agent service response cue information such as virtual cue cards, narrative text, hyperlinked web pages, or other easily readable sequence of information to use in assisting the customer. The service agent responds to the customer's service request by referring to the service response information, as shown in block 334.

In traditional customer service calls or interactions, the call or interaction may end at this point. However, according to the customer service marketing methods described herein, the actions taken by the service agent and CSM server continue in FIG. 4. Importantly, the service response information described in blocks 330, 332 and 334 may include transitional hints that the service agent provides to the customer regarding additional products or services marketed to the customer.

Referring now to FIG. 4, the CSM server obtains current offers, as shown in block 410. The current offers may be provided and/or offered by the provider of the product or service about which the customer initiated the customer service interaction and/or may be provided by a third party. The third party may have a strategic relationship with or be a company related to the provider of the product or service about which the customer initiated the customer service interaction. The current offers are customized for the particular customer based on information obtained and processed by the CSM server. The CSM server guides the service agent in presented the targeted, customized offer to the customer in and effort to cross-sell, up-sell or otherwise deliver an additional product or service to the existing customer.

The CSM server may prepare a compendium score for each of the current offers. The compendium score may be prepared during the customer interaction with the service agent in real time. The compendium score may be computed based on the results of one or more of blocks 412, 414, 416, 418 and/or 420. The compendium score may include analysis and evaluation of various data concerning the customer, the particular offer, similarly situated customers, the current interaction between the customer and the service agent, each of which may influence the other.

The CSM server may evaluate the eligibility of the customer for the current offers, as shown in block 412. The CSM server may evaluate whether the customer is qualified for the current offers, as shown in block 414. The eligibility and qualification may be evaluated based on information already in the possession of the CSM server and/or information obtained from one or more third party providers. Eligibility may be based on specific constraints of a product or service offer or a financial ranking of the customer. For example, eligibility may be based on whether an offer is available in a particular state. For example, eligibility may be based on the credit score of the customer. Even though a credit score of the customer may already be stored by the CSM server, it may be preferred to obtain a more recent or current credit score to evaluate the eligibility of the customer for a financial product offer. In this example, the CSM server may communicate with a third party server over the Internet or via a direct connection to obtain a current credit score, other financial ranking information, or specific financial information about the customer. In one embodiment, the eligibility may be based on a determination of whether a customer's credit score, net worth, total assets, total cash reserves, checking account, savings account, or other financial measure exceeds a system set minimum, is less than a system set maximum, is within a desired range, or other comparison.

The determination of qualification may be similar to or involve analysis of some of the same information as the eligibility evaluation. Eligibility and qualification may involve different analyses of similar information. For example, eligibility may consider whether the customer has a credit card or has a certain number of credit cards, and qualification may involve analysis of the current balance owed on the customer's credit cards or the total credit available via credit cards to the customer. Eligibility may consider whether the customer owns a single family residence, and qualification may involve analysis of the age of the home, the loan to value ratio of the current loan on the home, whether there are any second mortgages or liens on the home, etc. That is the qualification analysis may consider general or broader information, a macro view of information, while the qualification analysis may look at a more narrow or micro view of that information.

The CSM server may evaluate the propensity of the customer for the current offers, as shown in block 416. The propensity calculation may be based on whether similarly situated customer's accepted the particular offer. That is, evaluation of how other similarly situated customers responded to the particular offer, where a similarly situated customer is, for example, a customer with one or more of the same or similar income, marital status, number of dependents, zip code, area code, age range, credit score range, asset portfolio, and/or others.

The CSM server may evaluate the economic value and other financial attributes of the current offers for the customer, as shown in block 418. The economic value may include analysis of various financial characteristics of the customer to determine whether an eligible and qualified customer will receive a benefit from the particular offer. The economic value may be determined by evaluating whether the customer will profit from the particular offer. For example, if an investment product is offered, is the projected return on the investment sufficiently high. The economic value evaluation may also include analysis of the projected economic return or profit to the product and/or service provider.

The CSM server may prepare client weightings for the customer, as shown in block 420. The client weightings may be strategic client weightings that may be computed based on financial information, demographic information, and other information about the customer. For example, the larger the customer debt the greater a particular weighting; the larger the liquid assets the greater a particular weighting; the older the home, the greater a particular weighting, etc. Depending on the offer, the same data may result in greater or smaller weightings. For example, when considering a home equity loan product offer, the larger the credit card debt, the greater the weighting; whereas, when considering a refinancing of a home loan offer, the larger the credit card debt, the lower the weighting. The client weightings may, in addition or in the alternative, be based on client strategic objectives of the offer product or service provider. When client strategic objectives are considered, information may be evaluated to weight offers based upon the goals of the product or service provider. For example, a bank may want to weight demand deposit offers higher in a particular geographic region (e.g., municipality, county, state, or larger area) based upon bank expansion objectives.

The CSM server may prepare a compendium score for each of the current offers, as shown in block 422. The compendium score may be computed based on the results of one or more of blocks 412, 414, 416, 418 and/or 420. The compendium is a dynamic, evolving calculation that takes into consideration continuous tracking of customer responses, previous customer service interaction information, specific outcomes of customer service interactions and offers, and other information about the customer and similarly situated customers. The compendium score may also include consideration and/or evaluation of one or more of an historic success rate, trend information, client specific attributes, interaction and feedback results, and others.

The historic success rate may include consideration of customer satisfaction with the product, similarly situated accepting customer default rate regarding a financial product, and other information gleaned from analysis involving customer satisfaction with the product or service provided and/or product or service provider satisfaction with similarly situated accepting customers. The historic success rate information may be shared by the third party provider of the offer. The historic success rate information may be prepared by the CSM server based on locally stored information, may be prepared based on real time information received directly from one or more third party servers or received over a public or private network from one or more third party servers.

Trend information may be compiled to reflect which offers were provided over a period of time (e.g., two hours, a day, a week, a month, a quarter, a year, etc.) to certain customers. Trend information may be compiled to reflect which offers were accepted by customers over a period of time (e.g., two hours, a day, a week, a month, a quarter, a year, etc.). Trend information may be based on the historic success rate information. Trend information may be computed by the CSM server and/or one or more third party servers.

The client specific attributes may include detailed financial information (e.g., liquid assets, total debt, time and/or sum remaining on auto loan, time and/or sum remaining on home loan, etc.), property ownership information, product ownership information, and demographic data such as residence location (e.g., city, county and/or state), residence type (e.g., single family home, condominium, apartment), size of residence, car type (e.g., SUV, sedan, sports car)

The interaction and feedback results may include various information provided by the customer during the service interaction with the service agent during the current customer telephone call or interaction. The interaction and feedback results may include, in addition or in the alternative, information from prior customer interaction with a service agent.

The CSM server may select one of the current offers based on the compendium to provide to the customer, as shown in block 424. The CSM server prepares a customized, targeted offer for the customer, as shown in block 426. The service agent reviews information on the service agent computer screen provided by CSM server, as shown in block 428. The information may include or be offer cue information that includes text, hyperlinked web pages, and other similarly organized information assembled for the specific customer in real-time that the service agent uses to present a customized, targeted offer to the customer. The offer cue information may be provided to the service agent via a graphical user interface on the service agent's computer. Using the offer cue information, the service agent provides a customized, targeted offer to the customer, as shown in block 430. If the customer agrees to purchase a product or service described in the customized, targeted offer, or participate in a program described in the offer, the service agent may obtain any needed information for the product or service which the customer has agreed to purchase or participate in. The service agent may, in some embodiments, transfer the customer to a specialist either in the same company or at a third party company to facilitate the customer's purchase of the product or service described in the customized, targeted offer.

We reiterate that, regarding FIGS. 3 and 4, the actions taken in FIG. 4 may be performed concurrent with and/or interleaved with the actions taken in FIG. 3. More specifically, the actions in blocks 410 to 422 of FIG. 4 may be performed concurrently with and/or interleaved with the actions taken in blocks 318 to 334 of FIG. 3. In addition, regarding FIGS. 3 and 4, additional and fewer steps may be taken, and the steps as shown may be combined or further refined to achieve the methods described herein.

Although the methods set forth in FIGS. 3 and 4 describe an embodiment that involves communications between service agents and customers by telephone, the methods may be implemented during service agent—customer communication by any medium. That is, the communications between the service agent and the customer which are described as occurring by telephone may also occur during text message exchanges emanating from a computer, telephone or other computing device, or other interactive communication technique.

An example of the method includes considering whether to present current offers such as a home equity line of credit, refinanced home loan, loan consolidation, home warranty and auto warranty to a customer based on the compendium score that may include evaluation of the customer's credit score, credit card balances, home value, home loan balance, home age, auto loan balance, auto age, customer geographic location, customer propensity segmentation, product or service economics and other information available locally or obtainable in real time from a third party. If a compendium score for one of the offers exceeds a certain minimum threshold, in one embodiment, the offer may be presented to the customer. If the customer is interested in learning more about the offer or accepting the offer, the customer may be directed to a specialist. Whether the customer wanted to learn more information about the offer, accepted the offer or rejected the offer is processed by the CSM software and used in computing the compendium scores for other customers. In this way the compendium score is dynamic and includes real time feedback.

Closing Comments

The foregoing is merely illustrative and not limiting, having been presented by way of example only. Although exemplary embodiments have been shown and described, it will be apparent to those having ordinary skill in the art that changes, modifications, and/or alterations may be made, none of which depart from the spirit of the invention. All such changes, modifications and alterations should therefore be seen as within the scope of the invention.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “and/or” means that the listed items are alternatives, but the alternatives also include any combination of the listed items.

It is claimed:

1. A method comprising:
receiving a customer communication from a customer;
assigning the customer to a service agent;
receiving an information request from the service agent, the information request information obtained by the service agent from the customer;
providing response information to the service agent to provide to the customer, the response information based on the information request;
obtaining a plurality of current offers;
preparing a compendium score for each of the current offers, the compendium score based on analysis of some of
an eligibility of the customer for the current offer,
a qualification of the customer for the current offer,
a propensity of similarly situated customers to accept the current offer,
an economic value of the current offer to the customer,
a client weighting for the current offer,
trend information for the current offer among a plurality of customers,
an historic success rate for the current offer among the plurality of customers,
wherein the preparing the compendium score is a dynamic, evolving calculation;
selecting as a selected offer one or more of the current offers to provide to the customer based on the compendium scores;
providing offer cue information to the service agent based on the selected offer, the cue information to be used by the service agent to provide the selected offer to the customer.

2. The method of claim 1 further comprising:
transferring the customer to a specialist to facilitate the customer's purchase of a product or a service described in the selected offer.

3. The method of claim 1 wherein the offer cue information is provided via a graphical user interface on a display accessible to the service agent.

4. The method of claim 1 wherein the compendium score is based in part on customer data concerning the customer and customer data of similarly situated customers.

5. The method of claim 1 wherein the customer information includes client specific attributes.

6. The method of claim 1 wherein the compendium score is based further on consideration of a plurality of feedback results for the customer.

7. The method of claim 1 wherein the compendium score takes into consideration continuous tracking of similarly situated customer responses to offers and previous customer service interaction information for all customers.

8. A system comprising:
a processor
a memory coupled with the processor
a machine readable medium coupled with the processor, the machine readable medium having instructions stored thereon which when executed cause the system to perform operations including:
receiving a customer communication from a customer;
assigning the customer to a service agent;
receiving an information request from the service agent, the information request information obtained by the service agent from the customer;
providing response information to the service agent to provide to the customer, the response information based on the information request;
obtaining a plurality of current offers;
preparing a compendium score for each of the current offers, the compendium score based on analysis of at least three of
an eligibility of the customer for the current offer,
a qualification of the customer for the current offer,
a propensity of similarly situated customers to accept the current offer,
an economic value of the current offer to the customer,
a client weighting for the current offer,
trend information for the current offer among a plurality of customers,
an historic success rate for the current offer among the plurality of customers,
wherein the preparing the compendium score is a dynamic, evolving calculation;
selecting as a selected offer one or more of the current offers to provide to the customer based on the compendium scores;
providing offer cue information to the service agent based on the selected offer, the cue information to be used by the service agent to provide the selected offer to the customer.

9. The system of claim 8 wherein the machine readable medium has further instructions stored thereon which when executed cause the system to perform operations further comprising:
transferring the customer to a specialist to facilitate the customer's purchase of the product or service described in the selected offer.

10. The system of claim 8 wherein the offer cue information is provided via a graphical user interface on a display accessible to the service agent.

11. The system of claim 8 wherein the compendium score is based in part on customer data concerning the customer and customer data of similarly situated customers.

12. The system of claim 8 wherein the compendium score is based on evaluation of three or more factors from the group including customer eligibility, customer qualification, customer propensity, economic value, and client weightings.

13. The system of claim 12 wherein the compendium score is further based on consideration of at least one of an historic success rate, a trend information, a plurality of client specific attributes, and a plurality of feedback results.

14. The system of claim 8 wherein the compendium score is a dynamic, evolving calculation that takes into consideration continuous tracking of customer responses to offers and previous customer service interaction information for all customers.

15. A machine readable medium having instructions stored thereon which when executed by a processor cause the processor to perform operations including:
receiving a customer communication from a customer;
assigning the customer to a service agent;
receiving an information request from the service agent, the information request information obtained by the service agent from the customer;
providing response information to the service agent to provide to the customer, the response information based on the information request;
obtaining a plurality of current offers;
preparing a compendium score for each of the current offers, the compendium score based on analysis of at least three of
an eligibility of the customer for the current offer,
a qualification of the customer for the current offer,
a propensity of similarly situated customers to accept the current offer,
an economic value of the current offer to the customer,
a client weighting for the current offer,
trend information for the current offer among a plurality of customers,
an historic success rate for the current offer among the plurality of customers,
wherein the preparing the compendium score is a dynamic, evolving calculation;
selecting as a selected offer one or more of the current offers to provide to the customer based on the compendium scores;
providing offer cue information to the service agent based on the selected offer, the cue information to be used by the service agent to provide the selected offer to the customer.

16. The machine readable medium of claim 15 having further instructions stored thereon which when executed cause the processor to perform operations further comprising:
transferring the customer to a specialist to facilitate the customer's purchase of the product or service described in the selected offer.

17. The machine readable medium of claim 15 wherein the offer cue information is provided via a graphical user interface on a display accessible to the service agent.

18. The machine readable medium of claim 15 wherein the compendium score is based in part on customer data concerning the customer and customer data of similarly situated customers.

19. The machine readable medium of claim 15 wherein:
the compendium score is based on evaluation of three or more factors from the group including customer eligibility, customer qualification, customer propensity, economic value, and client weightings; and
the compendium score is further based on consideration of one or more of an historic success rate, a trend information, a plurality of client specific attributes, and a plurality of feedback results.

20. The machine readable medium of claim 19 wherein the compendium score is a dynamic, evolving calculation that takes into consideration continuous tracking of customer responses to offers and previous customer service interaction information for all customers.
